(19) United States
(12) Patent Application Publication
(10) Pub. No.: US 2024/0262765 A1
(43) Pub. Date: Aug. 8, 2024

(54) LOW VOLUME FRACTION, ENHANCED ENERGY RELEASE SCAFFOLDS FOR ENERGETIC MATERIAL

(71) Applicant: Lawrence Livermore National Security, LLC, Livermore, CA (US)

(72) Inventors: James Lewicki, Oakland, CA (US); Michael J. King, Livermore, CA (US); Nicholas Hanson Loey, Livermore, CA (US)

(21) Appl. No.: 18/106,921

(22) Filed: Feb. 7, 2023

(51) Int. Cl. C06B 45/10; B33Y 70/10; B33Y 80/00; C06B 21/00; C06B 29/00; C06B 33/06

(52) U.S. Cl. CPC C06B 45/10; B33Y 70/10; B33Y 80/00; C06B 21/0058; C06B 29/00; C06B 33/06; B29C 64/112; B29K 2307/04; B33Y 10/00

(57) ABSTRACT

A product includes a three-dimensional scaffold structure having an open cell geometry with interconnected channels for allowing continuous communication throughout a volume of the scaffold structure. The scaffold structure is configured to enhance mechanical strength of an energetic material. A fuel material is present in the scaffold structure and/or a second material is coupled to the scaffold structure. The fuel material is configured to increase an output of energy release relative to an output of energy release from the scaffold structure having the fuel material not present.

This invention was made with Government support under Contract No. DE-AC52-07NA27344 awarded by the United States Department of Energy. The Government has certain rights in the invention.

### BACKGROUND

Large accelerations (i.e., high G-loadings) can produce significant mechanical stresses in high-performance energetic materials that will mechanically degrade, deform, or cause failure in them, resulting in excessive deformation, cracking, fragmentation, etc. and adversely impacting safety or performance. A munition containing high explosive material may be subjected to very high G-loadings throughout its use. For instance, very high G-loadings can occur during launch of an artillery fired munition, and during impact and penetration by the penetrating munition. During gun launch, an artillery fired munition will experience high axial G-loads in the gun barrel (set back) and as it exits the barrel (set forward), as well as high lateral G-loads doe to lateral shaking in the barrel (balloting). A penetrating munition undergoes high axial G's as it impacts a target and, for impacts that occur at an angle, high lateral G's as it penetrates into the target. However, high-performance energetic material, e.g., high explosive (HE) material, high velocity propellant, etc., typically are mechanically weak and thus susceptible to damage under very high G-loadings.

Damage to high-performance energetic material due from these G-loadings can severely affect its performance or pose a safety risk. For example, damaged HE material may not correctly detonate, e.g., it may not detonate at all or it may only deflagrate (i.e., burn) instead of detonating, thereby resulting in an output significantly lower than intended. Alternately, damaged HE may deflagrate or detonate prematurely resulting in lethal effects not being delivered effectively to the target, and thereby creating a safety risk to the operators (e.g., an artillery fired munition may detonate in the gun barrel). One example of a blast material that cannot be used in munitions that undergo high G-loadings is a typical blast-enhancing high explosive (e.g., AFX-757) that contains explosive material (e.g., HMX, RDX, etc.), a metal fuel (e.g., aluminum powder), an oxidizing agent (e.g., ammonium perchlorate (AP)), and a polymer binder. These explosive materials often have poor mechanical properties and are prone to spontaneous deflagration during high-G penetration events.

For some munitions (e.g., artillery fired munitions), cracked and damaged high explosives can also cause material to shift and move while in flight, which can impair flight stability and degrade munition accuracy even if detonation is not impaired.

In another example, damage to a high burn velocity propellant used in some solid rocket motors can impair performance and cause failure of the rocket motor. During rocket motor burn, high performance, high burn-rate, high specific impulse fuels undergo controlled, yet violent, highly energetic chemical reactions. The mechanical effects of this violent energetic reaction (pressure waves, mechanical stresses, and vibrations) can cause the unburned propellant within the solid rocket body to be damaged, delaminate from the rocket body wall, and/or slide out or break up and fall out during burn. Damaged propellant may also cause an uneven burn rate within the rocket motor during a flight or launch event. In addition, damage to the propellant may degrade or disrupt the overall propellant geometry (e.g., tapered hole) resulting in degradation or loss of burn rate tailoring. Damaged propellant leads to an incomplete and/or unpredictable burn, and thus affects performance (e.g., unexpected detonation, altered thrust, etc.) of the solid rocket motor.

In another example of a reinforcing system, a modified high energetic material composition includes a metal fuel, inorganic oxidizer, and polymer binder. However, a significant drawback of these compositions (e.g., modified propellants, modified HE, etc.) that contain a metal fuel and an oxidizer (for example, aluminized explosives with AP) is the compositions often have poor mechanical properties, and are less able to survive energetic initiation to completion. For example, such modified explosives (e.g., AFX-757) are prone to spontaneous deflagration during high-G penetration events. Another drawback of modified propellant composition having rods or wires for mechanical support is the modified propellent has limited burn rate characteristics compared to unmodified propellant. Moreover, in some modified propellants, a polymer binder is included that only provides a weak additional fuel that may be “oxidizable” but is not an oxidizer so the polymer binder cannot enable more fuel burn for increased output.

Structural reinforcement of mechanically weak energetic material compositions has been challenging and currently is applied in only limited settings. It is relatively difficult to incorporate a structural reinforcements into energetic materials without unacceptably sacrificing energetic output. One example of a structurally reinforced HE is a metallic lattice structure or foam that is filled with castable HE material. The lattice or foam reinforces the HE after it is cured. In another example, a discrete heterogenous reinforcing phase or filler may be blended into a HE to form an energetic composite material to attempt to improve the mechanical properties of the HE composite.

A significant drawback of including metallic reinforcing structures, reinforcing fillers, etc. in an energetic material is that the structure occupies volume that would contain energetic material in a non-reinforced material, essentially replacing a highly energetic material (HE, propellant, etc.) with a less energetic (e.g., metal) or non-energetic material (e.g., polymer) thereby resulting in a loss of net energetic output of the explosive charge, solid rocket motor, etc. In particular, metals, reinforcing fillers, etc. only burn effectively when present as very small particles and when sufficient oxygen is available. For example, detonation of the HE typically does not provide an environment for the metal to effectively burn because the metal is not sufficiently reduced to a small particle size and sufficient oxygen is not available for the metal structure to burn, and thus, the amount of energy output by burning a metallic reinforcing structure is limited and reduces the energetic performance by the munition.

Moreover, reinforcing fillers, metallic structures, foams, etc. have been shown to adversely affect the detonation, burn rate, etc. characteristics of the HE, propellant, etc. Another undesirable aspect is that a metallic reinforcing structure is relatively heavy thereby adding significant weight to the munition compared to a non-reinforced energetic material.

Currently, development of energetic materials includes the unfortunate dilemma to either structurally reinforce the energetic material to survive and perform in high-G environments, at the cost of reduced energy output, possibly poor burn characteristics, and increased weight, or to maintain optimal energy output at the cost of poor mechanical performance that could preclude the use of the energetic material in high-G environments. There is a need to increase mechanical strength of energetic material while reducing or preferably eliminating losses in energy output that may accompany the increased mechanical strength.

### SUMMARY

In one embodiment, a product includes a three-dimensional scaffold structure having an open cell geometry with interconnected channels for allowing continuous communication throughout a volume of the scaffold structure. The scaffold structure is configured to enhance mechanical strength of an energetic material. A fuel material is present in the scaffold structure and/or a second material is coupled to the scaffold structure. The fuel material is configured to increase an output of energy release relative to an output of energy release from the scaffold structure having the fuel material not present.

In another embodiment, an ink composition for forming a three-dimensional scaffold open cell structure for energetic material includes a polymer resin comprising a carbon fiber, an additive configured to enhance energy release potential from the energetic material, and a thixotropic agent.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a schematic drawing of an energetic material in a casing under applied stress.

FIG. 2 is a schematic drawing of an energetic material with a scaffold, according to one embodiment.

FIG. 3 depicts images of a structure, according to one embodiment. Part (a) depicts an image of a structure having open cell geometry, and part (b) depicts an image of the structure filled with an energetic material.

FIG. 4 depicts images of a carbonized structure, according to one embodiment. Part (a) is an image of a lattice, part (b) is a schematic diagram of a portion of a lattice, part (c) is an image of a top down view of a structure, and (d) is an image of a side view of a structure,

FIG. 5 is a flow chart for a method of forming a three-dimensional structure having an open cell geometry, according to one embodiment.

FIG. 6 depicts a series of steps of a method of forming a three-dimensional structure having an open cell geometry, according to one embodiment. Part (a) depicts a triply periodic minimal surface concept, part (b) depicts a model of the structure having a 20 vol. %, part (c) depicts an optimal direct ink write (DIW) toolpath for printing the triply periodic minimal surface structure, part (d) depicts a printed triply periodic minimal surface structure, part (e) depicts a machined printed triply periodic minimal surface lattice structure having an open cell geometry, and part (f) is a magnified view of the machined printed triply periodic minimal surface lattice structure having open cell geometry.

### DETAILED DESCRIPTION

The following description is made for the purpose of illustrating the general principles of the present invention and is not meant to limit the inventive aspects claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

It is also noted that, as used in the specification and the appended claims, wt. % is defined as the percentage of weight of a particular component relative to the total weight/mass of the mixture. Vol. % is defined as the percentage of volume of a particular compound relative to the total volume of the mixture or compound. Mol. % is defined as the percentage of moles of a particular component relative to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The present disclosure includes several descriptions of exemplary “inks” used in an additive manufacturing process to form the inventive aspects described herein. It should be understood that “inks” (and singular forms thereof) may be used interchangeably and refer to a composition of matter comprising a plurality of particles coated with/dispersed throughout a liquid phase such that the composition of matter may be “written,” extruded, printed, or otherwise deposited to form a layer that substantially retains its as-deposited geometry and shape with perhaps some, but preferably not excessive, sagging, slumping, or other deformation, even when deposited onto other layers of ink, and/or when other layers of ink are deposited onto the layer. As such, skilled artisans will understand the presently described inks to exhibit appropriate rheological properties to allow the formation of monolithic structures via deposition of multiple layers of the ink (or in some cases multiple inks with different compositions) in sequence.

The following description discloses several preferred structures formed via direct ink writing (DIW), extrusion freeform fabrication, or other equivalent techniques and therefore exhibit unique structural and compositional characteristics conveyed via the precise control allowed by such techniques. The three-dimensional structure formed by DIW may have a single continuous filament that makes up at least two layers of the 3D structure.

The following description discloses several preferred embodiments of a composition for forming a low volume fraction, enhanced energy release scaffold for energetic material and/or related systems and methods.

In one general embodiment, a product includes a three-dimensional scaffold structure having an open cell geometry with interconnected channels for allowing continuous communication throughout a volume of the scaffold structure. The scaffold structure is configured to enhance mechanical strength of an energetic material. A fuel material is present in the scaffold structure and/or a second material is coupled to the scaffold structure. The fuel material is configured to increase an output of energy release relative to an output of energy release from the scaffold structure having the fuel material not present.

In another general embodiment, an ink composition for forming a three-dimensional scaffold open cell structure for energetic material includes a polymer resin comprising a carbon fiber, an additive configured to enhance energy release potential from the energetic material, and a thixotropic agent.

A list of acronyms used in the description is provided below.
3D three-dimensional
AM Additive manufacturing
BET Brunauer, Emmet, and Teller
C Celsius
CAD computer aided design
CF carbon fiber
DIW direct ink writing
G-force gravitational force equivalent
HE high explosive
HMX tetrahexamine tetranitramine
ms millisecond
nm nanometer
TATB triaminotrinitrobenzene
TPMS triply periodic minimal surface
μm micron
vol. % volume percent
wt. % weight percent

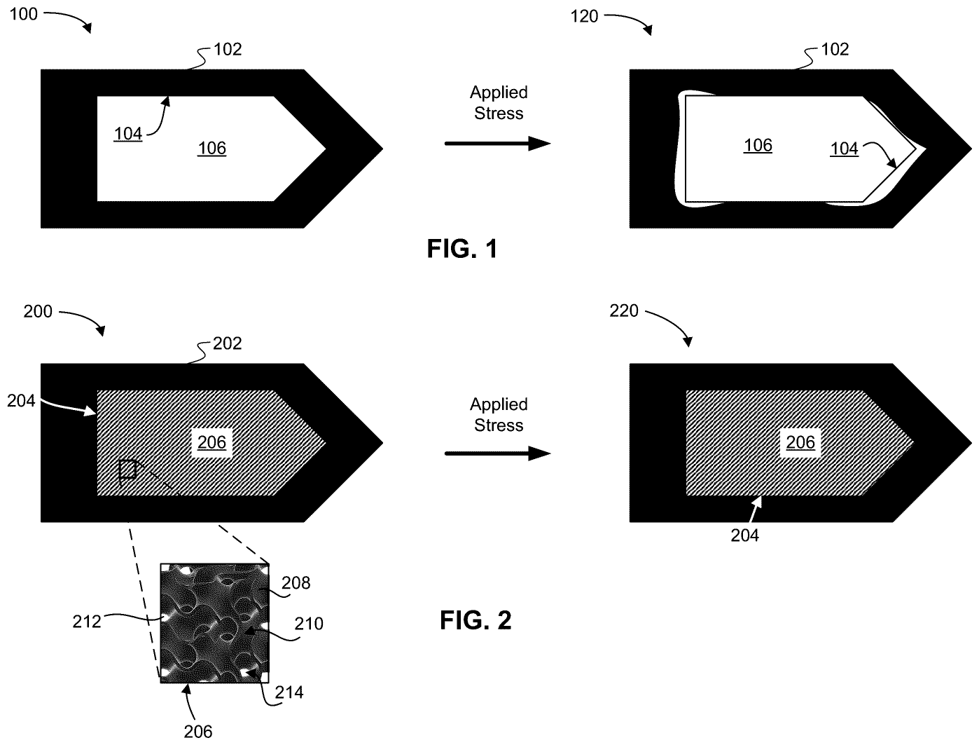

Various embodiments described herein overcome the challenges deformation and degradation of mechanically weak but energetically strong material. An example of damage to energetic material during applied stress is illustrated in the schematic diagram of FIG. 1. Before initiation and use 100, a munition 102 includes a cavity 104 comprising a large volume of an energetic material 106, such as a high-performance or high blast high explosive (HE) that is contained within a munition 102. Stresses 120 from high G-loads applied prior to initiation, such as stresses resulting from flight dynamics, impact, etc. causes the material 106 to mechanically deform, fail, crack, excessive displace, etc. with detrimental effects on guidance, energy output, explosive yield, etc. from the munition 102, or catastrophic failure of the munition 102 prior to initiation. The high-performance energetic material 106 is mechanically weak and cannot maintain structural integrity during application of high G-loads.

According to one embodiment, the mechanical stability of an energetic material is enhanced via the introduction of a low volume fraction, high strength, high modulus open cell scaffold composed of an additively manufactured (AM) carbon ceramic, a carbon fiber polymer composite, a metal particulate polymer composite, etc. The matrix scaffold structure not only mechanically stabilizes the energetic material (e.g., HE, propellant, etc.) by providing significant mechanical reinforcement of the energetic material, but in preferred approaches, it provides reserves of material to contribute to the burn. In these approaches, the matrix scaffold participates in the actual energy output, e.g., explosive, fuel burn, etc. of the system to output an equal or greater than expected energy output relative to the energetic material without the scaffold. Moreover, the scaffold structure material does not significantly impede the burn or detonation of energetic material, and further may create energy output comparable to or greater than the energetic material on its own. The embodiments described herein enable the use of explosives, propellants, etc. that are currently unavailable for use because they are too mechanically weak for applications having high G-loadings or otherwise subject to high strain and/or high strain rate mechanical stresses in application.

FIG. 2 depicts a schematic diagram of a product 202 as an example of a blast enhancing structural explosive, according to one embodiment. As an option, the present product 202 may be implemented in conjunction with features from any other inventive aspect listed herein, such as those described with reference to the other FIGS. Of course, however, such product 202 and others presented herein may be used in various applications and/or in permutations which may or may not be specifically described in the illustrative embodiments listed herein. Further, the product 202 presented herein may be used in any desired environment.

In one example, as illustrated in the schematic diagram in FIG. 2, before initiation and use 200, the product 202 includes a munition having a cavity 204 comprising a mechanically strong reinforced energetic material 206. A magnified portion of the reinforced energetic material 206 includes an open cell scaffold 208 having interconnected channels 210 throughout the volume of the scaffold 208 to enhance the strength of a castable energetic material 212 (e.g., HE) contained within the channels 210 of the scaffold 208. The interconnected channels 210 may be exposed channels 214 on the side of the structure. The scaffold structure has a low volume, high surface area, is stiff and strong, and may be comprised of a fuel material such as carbon. Low volume of the scaffold structure minimizes the amount of energetic material displaced by the scaffold, and high surface maximizes the burn of the scaffold by enabling a significant portion of the material to participate in the chemistry. The open cell geometry of the scaffold 208 enables the castable energetic to be cast about the scaffold 208 during manufacture, and facilitates effective burn of the energetic throughout the structure during the burn, detonation, etc. During applied stress 220, the scaffold-supported energetic material 206 contained within the product 200 (e.g., the munition) may be resistant to detrimental deformation by applied G-loads, such as flight dynamics, impact, etc., thereby avoiding catastrophic failure prior to initiation and retaining optimal energy output when it is detonated. The scaffold supported energetic material 206 may undergo small deformations from the applied G-load, but these will be on a much smaller scale and/or in more localized regions relative to how an unreinforced energetic material would respond, and do not affect the performance of the product 200.

According to one embodiment, a product includes a three-dimensional (3D) scaffold structure having an open cell geometry with interconnected channels for allowing continuous communication throughout a volume of the scaffold structure. The scaffold structure is configured to enhance mechanical strength of an energetic material when present in the channels. The scaffold structure has interconnected channels that allow infilling with an energetic material (e.g., injecting HE composite) into the channels such as during casting of castable energetic material. Moreover, the presence of the energetic material in the channels allows continuous burn of all the energetic material throughout the volume of the product (e.g., charge) without dead end cavities, constrictions, voids, etc. that interrupt optimal energy output. In a preferred approach, the scaffold structure is a triply periodic minimal structure (TPMS) lattice structure. A lattice structure has an open cell geometry allows communication between the channels so that the energetic material burns continually throughout the product.

In one approach, a closed cell geometry may allow continued burn if the cells were filled with certain high explosives, propellants, etc. such as an energetic material that propagates a detonation, burn rate, etc. through pressure waves that would likely traverse across the closed cells. Alternatively, there may be some energetic material (e.g., HE, propellant, etc.) that cannot burn through a closed cell structure. For example, a scaffold structure having closed cell geometry, or isolated pockets of energetic material inside closed cells, would be discontinuous and the energetic material in the cells may not continue to burn, release energy, etc. or may result in unpredictable shockwave propagation through the charge that could result in a spoiled detonation or burn. Moreover, a significant drawback of the scaffold structure having closed cell structure is the difficulty of loading energetic material into the scaffold structure, e.g., after printing the closed cells would be closed to loading energetic material.

According to one embodiment, a scaffold structure is configured to function as an independent reinforcing lattice that adds performance to an overall energy producing product, such as a propellant assembly, blast explosive, etc. In one approach, a fuel material is present in the scaffold structure, where the fuel material is configured to increase an output of energy release relative to an output of energy release from the scaffold structure having the fuel material not present. The presence of the fuel material in the scaffold structure may provide an output of energy release that is the same or greater than the output of energy release of the energetic material with no fuel material (e.g., no scaffold structure) present.

In another approach, both a fuel material and an oxidizer are present in the scaffold structure, where the fuel and oxidizer materials are configured to increase the energy output relative to that which would have been achieved with just the fuel and not the oxidizer. In yet another approach, the fuel and the oxidizer material are configured to increase the energy output relative to that which would have been achieved with neither the fuel nor the oxidizer present.

In one approach, the scaffold structure is formed with a fuel material being a carbon-organic precursor. For example, the fuel material may include a polymer carbon fiber material (e.g., a carbon fiber reinforced polymer). In other examples, the fuel material may include reinforcing fillers such as a ceramic, a glass, a silica, etc. In another approach, the scaffold structure is formed with a fuel material being a carbon-carbon material where the structure is formed with a carbon fiber reinforced organic precursor, and then pyrolyzed to a carbon-carbon material. Preferably, the scaffold structure includes a stage 1 pyrolytic carbon-carbon material. For example, in an excess oxygen environment, a carbon-carbon scaffold structure may function as a source of fuel for the energetic material thereby benefitting the overall performance of the device. In one approach, the scaffold structure may include a second material coupled to the scaffold structure. In one example, a carbon-carbon scaffold has surface carbon atoms chemically functionalized with nitro groups that will act as oxidizers, for example, a nitrated carbon-carbon structure.

In another approach, the scaffold structure comprises a carbon-fiber reinforced polymer material having an oxidizer encapsulated into the polymer matrix. The oxidizer provides oxygen because, in accepting electrons, it frees oxygen ions that can then be used in the reaction to burn more fuel. In one approach, the scaffold structure includes a chlorate functionalizer, a chlorate molecule that functionalizes the scaffold structure as an oxidizer. The oxidizer may include chlorate particles, such as partially flocculated potassium perchlorate microparticles. For example, in an oxygen deficient, or environment absent of oxygen, a structure having an oxidizer offers various degrees of combustion and consumption of that additional fuel in the composition which therefore gives an overall greater output of energy.

In another approach, the scaffold structure comprises a thermoset composite matrix having a high loading of a fuel-oxidizer mixture therein. The fuel-oxidizer mixture includes the fuel material being a metal power (e.g., aluminum particles) and the second material being an oxidizer, such as a metal oxide (e.g., iron oxide). In preferred approaches, the fuel-oxidizer mixture of the thermoset composite matrix is in the form of a thermite composition, e.g., iron oxide and aluminum powder mixture. The scaffold structure comprising a fuel-oxidizer mixture is capable of an energetic redox reaction. In one approach, the structure may include the thermite component with some short carbon fiber to give the structure additional stiffness. Moreover, a thermite component of the scaffold structure provides additional energetic component and an oxidizer source. Unlike aluminum powders, which are fuels only and therefore burn, outputting energy only in the presence of oxygen (e.g., an air environment) in which detonation is occurring, a thermite composition includes a stoichiometric balance of both oxidizer and fuel and upon ignition no ambient oxygen from the environment is needed for the reaction and output energy. A thermite scaffold therefore can enhance the overall energetic output of the energetic material, independent of the presence or absence of environmental oxygen sources.

In another approach, the scaffold structure includes a thermoset composite matrix having a fuel material being a carbon powder. In yet another approach, the scaffold structure includes a thermoset composite matrix having a fuel material being a carbon-sulfur powder. A carbon powder may be included as an additional fuel with a second material being a polymer bound black powder (i.e., gunpowder) as a non-passive participating loading. A formulation that includes black powder-type additives may provide a “low-explosive” formulation.

In one approach, the scaffold structure may include a thermoset composite matrix that includes a loading of HE energetic powder. At a low loading of HE energetic powder as an additive, the scaffold structure comprised of a thermoset composite matrix with HE energetic powder provides a mechanically robust structure having a significant output of energy release relative to an output of energy release from the scaffold structure without the thermoset composite matrix and HE energetic powder present in the structure material. The HE energetic powder may be in the form of micronized HE dispersion. A low loading of the HE energetic powder as an additive to the thermoset composite matrix may be in a range of about 10 to 40 vol. % of total volume of the scaffold structure.

According to one embodiment, a high strength, high modulus open cell scaffold is configured to have a low volume relative to the total volume of the charge for enhancing mechanical stability of HE composite. In preferred approaches, the scaffold structure has mechanical strength and modulus comparable to common aluminum alloys, steel-like, etc. For example, tensile and compressive moduli is preferably in a range of 10 to 70 GPa and strength (tensile and compressive) is preferably in a range of 50 to 400 MPa.

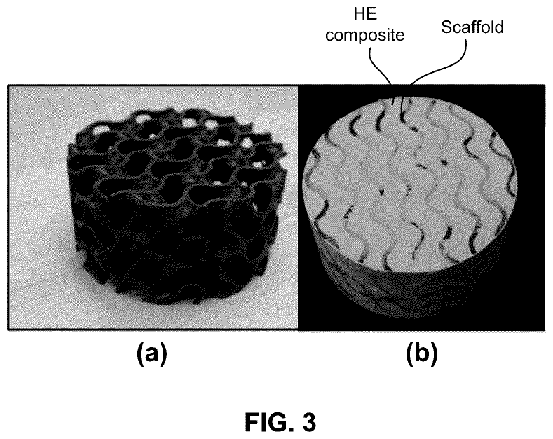

According to one embodiment, the product includes an energetic material present in the interconnected channels of the scaffold structure, where a volume of the scaffold structure is less than 25 vol. % of the total volume of the product. For example, as illustrated in FIG. 3, part (a) depicts an image of a scaffold structure, a scaffold, having an open cell geometry with interconnected channels that provide continuous communication throughout the volume of the structure. In one approach, the continuous communication is provided in portions of the scaffold structure. In another approach, the continuous communication is provided through the entire scaffold structure. The scaffold structure as shown in part (a) is comprised of a carbon-carbon material. Part (b) depicts an image of the scaffold structure filled with energetic material such as HE composite. In preferred approaches, a product, e.g., a charge, includes the scaffold and the energetic material where the volume of the scaffold structure is less than 25 vol. % of the total volume of the product (e.g., scaffold and energetic material).

According to one embodiment, the product comprising the scaffold structure comprised of a fuel material and having an open cell geometry is configured to resist deformation, and failure in the relevant load path of the assembly, of the energetic material under an applied force. In various approaches, a carbon, a polymer bound metal/metal fuel structure, a combined carbon and polymer bound metal/metal fuel structure, etc. is included in a product as a distinct second component of a product used for optimal energy release (e.g., a rocket motor, an explosive, etc.). The scaffold structure is configured to occupy a minimum volume of the total energetic material of the product (e.g., the propellant, HE composite, etc.) to strengthen the energetic material. Moreover, the scaffold structure is an independent source of fuel for the product, e.g., the scaffold structure is not formed from the energetic material. Moreover, the performance of the energetic material in terms of optimal energy release is enhanced in the presence of the scaffold structure. For example, the open cell geometry of the lattice-designed scaffold, as described herein, augments the burn rate of propellant.

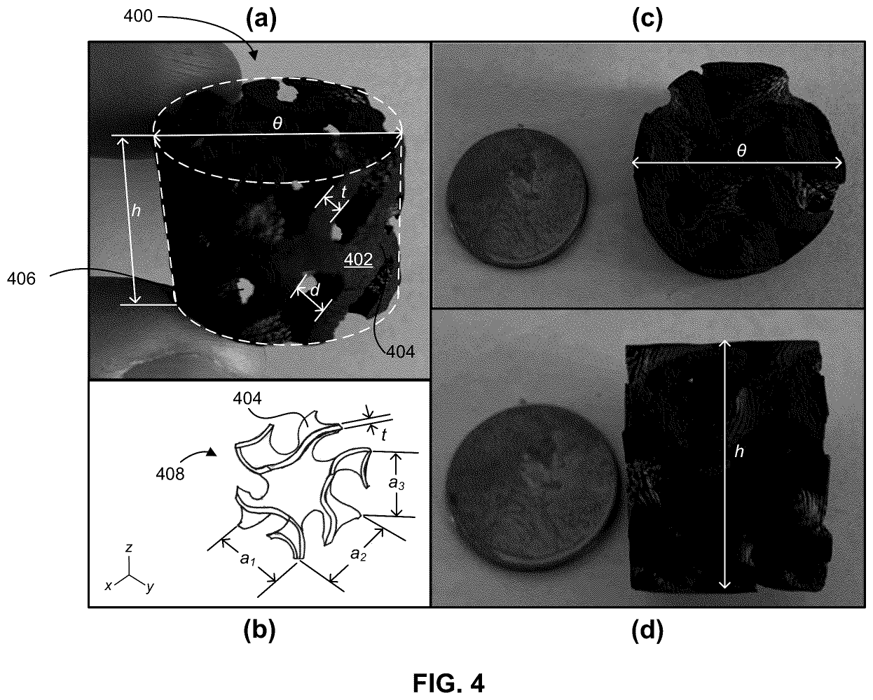

According to one embodiment, a structure may be printed as a TPMS lattice structure having an open cell geometry. The TPMS is free of intersections and thus has continuous channels interconnected from one end of the structure to the opposite end of the structure. In one approach, as shown in FIG. 4 a structure 400 is printed as a gyroid pattern having an open cell geometry. Part (a) is an image of a lattice structure 400 having an open cell geometry. The structure may be a cylinder, cube, rectangular prism, etc. The structure is formed comprising material 402 such as a carbon-carbon material as illustrated in the images of FIG. 4.

The gyroid pattern includes an arrangement of features, walls 404, etc. that form interconnected channels 406 throughout the volume of the scaffold structure 400, where for the illustrated cylinder the volume of the structure is

$$π {( \frac{θ}{2} )}^{2} h ,$$

h is the height of the structure and θ is the diameter of the structure, as illustrated in FIG. 4. In other approaches, a volume of a cubic scaffold structure may be calculated according to the length of one outer edge, (e.g., h is an outer edge, V=h³).

The geometric pattern may be comprised of a pattern including unit cells repeating throughout the volume of the scaffold structure. In one example, the schematic drawing of part (b) may illustrate a repeating portion of a gyroid pattern of the printed scaffold structure 400 of part (a) of FIG. 4. The gyroid pattern includes a repeating unit cell 408 defined by three unit cell dimensions a₁, a₂, and a₃ in the y-, x-, and z-directions, respectively, where the z-direction is orthogonal to an xy plane. The unit cell 408 is repeated throughout the volume of the cylindrical structure 400 (defined by θ and h of the structure 400). The walls 404 of the unit cell 408 are defined by the unit wall thickness t. In one approach, the wall thickness, t, may define the mechanical strength of the scaffold, the diameter d of each interconnected channel, etc.

The images of parts (c) and (d) show the size of an embodiment of a carbon-carbon lattice structure relative to a penny in a top view and a side view, respectively. Dimensions of the structure, e.g., diameter θ, height h, of the structure may be a length engineered for the application of the structure. The dimensions of the structure may be defined by the printing technique used for printing the structure. For example, the scaffold structure may be a cube having a volume according to a length of a side of a structure, the scaffold may be a rectangular prism having a volume according to the h, width w, and length l of the structure, etc. These are by way of example only and are not meant to be limiting in any way.

In various approaches, shape of the scaffold structure may be defined according to the application of the energetic product (e.g., high explosive, solid rocket, etc.). In some approaches of using the scaffold structure with HE material in a munition, a scaffold structure has a cylindrical shape. In other approaches, the scaffold structure has a non-cylindrical shape. The structure is defined as the positive volume of a TPMS lattice and channels are defined as the negative volume. Without wishing to be bound by any theory, a TPMS lattice provides structural reinforcement and maintains maximum surface area exposure of the lattice to the explosive as compared to the lesser surface area exposure provided by the more widely utilized cubic (BCC or FCC) lattice. TPMS structures are typically defined by a 3D trigonometric equation with modifiers for thickness t of the walls of the structure and dimensions a₁, a₂, and a₃ of the unit cell.

In some approaches, optional features may be designed into the scaffold structure to include a graded lattice structure of variable density to compensate for non-linear applied stresses or provide non-linear mechanical response. In one example, regions of the structure may have more lattice material (e.g., denser lattice pattern) and other regions of the structure may less lattice material (e.g., lattice pattern with wider spacing between filaments). For example, for hammering an explosive into a borehole, the scaffold may preferably have increased lattice material at the tip, front, top, etc. e.g., the portion of the product that is nearest the location of impact such as the portion in contact with the borehole or the portion in contact with the installation tool, and less lattice material in other portions of the product. In one example of a propellant, the burn may be tailored by the structure of the lattice, such as regions of denser lattice alternating with regions having less dense lattice, thereby generating a variable burn rate, e.g., fast burn, slow burn, fast burn, etc. pattern dependent on the density of the lattice in the scaffold present in the propellant.

In one approach, the scaffold structure may be a graded lattice having a predefined gradient of density of the scaffold material throughout the volume of the structure. In one approach, the graded lattice includes a first region having a first unit density of the scaffold material and a second region has a second unit density of the scaffold material, and the first unit density is different than the second unit density. For example, in one region of the structure, the unit density of scaffold material is less than unit density of scaffold material a second region, and the lattice has a denser geometric pattern of the material. In another region of the structure, the unit density of the material is greater than the unit density of the material of the first region, and lattice has a less dense geometric pattern. The structure comprising the first, second, n-regions comprise a predefined graded density of scaffold material.

In some approaches, the gradient density of the structure may be defined by adjusting the value of at least one of the dimensions of the unit cell, e.g., a₁, a₂, and/or a₃ as illustrated in part (b) of FIG. 4, to change the unit cell. In one approach, the adjusted dimension(s) of the unit cell may warp the unit cell out of a cubic pattern repeated throughout the volume. In one approach, the adjusted dimension(s) of the unit cell may be scaled with respect to adjacent regions of unit cells to create a gradient of density throughout the volume of the structure.

In one approach, the scaffold structure may have a graded lattice having a predefined gradient of wall thickness t throughout the volume of the structure. In one approach, each singular unit cell may be configured to have a gradient of wall thickness t such that each repeating unit cell has a predefined gradient of wall thickness. In another approach, the unit cells comprising the total volume of the charge (e.g., structure+HE material), may be configured to have a gradient of wall thickness throughout the volume thereby altering the ratio of scaffold structure material to HE material within each unit cubic volume. For example, a graded scaffold structure includes a first region of unit cells having first wall thickness t₁ and a second region unit cells having a second wall thickness t₂, and the first wall thickness t₁ is different than the second wall thickness t₁. For example, in one region of unit cells of the scaffold structure, the wall thickness is thinner than the wall thickness in second region of unit cells. The scaffold structure (e.g., lattice) has less matrix material due to the thinner walls in a portion of the scaffold structure compared to a second portion having more matrix material due to the thicker walls. The structure comprising the first, second, n-regions of walls comprise a predefined graded wall thickness throughout the volume of the structure.

In another approach, the scaffold structure may have a graded volume of matrix material having a predefined gradient of unit density and a predefined gradient of wall thickness throughout the volume of the structure. In various approaches, the gradient of density, wall thickness, etc. throughout the volume of the scaffold structure is incremental including greater than two different graded densities, two different wall thicknesses, etc. in the volume.

In one approach, a volume of the energetic material present in the interconnected channels of the scaffold structure is greater than 75 vol. % of the total product. A total volume of the scaffold structure is configured to replace no less than 25 vol. % of the total product comprising the structure and an energetic material. The 3D structural elements of the product include the material forming the scaffold structure and the pores formed by the geometric arrangement of the material. The total volume of the scaffold structure is the volume of the material forming and scaffold structure and does not include the volume of the pores formed by the geometric arrangement of the material, such as pores, voids, voids formed by interconnected channels, etc. The scaffold structure is structurally optimized to take the place of a minimum volume of HE charge volume, while maintaining a maximum increase in the resistance of the HE charge volume from deformation, distortion, or mechanical failure at over high dynamic stress environments—such as high axial or transverse G-loadings. In another approach, the scaffold may be structurally optimized to take the place of a minimum volume of propellent material in a solid rocket motor.

In one example of an HE composition having a 25 vol. % scaffold generates a better performance than a HE composition without a scaffold. In a preferred approach, a 20 vol. % lattice scaffold with HE composite generates a high output explosive, approximately 10 to 15% improved energy output compared to a TATB-based, mechanically robust, insensitive HE composite without the lattice scaffold. For example, 20 vol. % of HMX HE composite material can be replaced with a lattice scaffold and the product of the combined HMX with lattice generates an improved 10 to 15% energetic output compared to a 92.4 vol. % TATB, 7.6 vol. % fluoropolymer composite HE material. The energetic output being measured by detonation calorimetry measurements, essentially the heat of the reaction by how many joules output is generated. In this example, therefore a high-performance HMX based HE composite which is mechanically weak, is rendered mechanically robust and may output more energy than the state of the art, robust insensitive TATB-based HE composite.

In various approaches, the scaffold may be fabricated such that it: 1) contributes passively to the energy release of energetic material (e.g., as a fuel in an oxidative environment in the latter stages of the explosion), or 2) contributes actively when the scaffold is either chemically functionalized to provide its own oxidizer component (as in the case of a nitrated carbon-carbon structure) or an oxidizer (such as a perchlorate salt) is encapsulated into the polymer composite scaffold. In another approach, a scaffold structure may also be printed by AM using a thermoset composite matrix with or without carbon fiber reinforcement that contains various loadings of additional fuel such as aluminum powder or a fuel-oxidizer mix such as a thermite-providing additional means of passive or active participation in the output of the energy release from the energetic material. For example, the scaffold may comprise additional fuel providing additional means of passive or active participation in HE output.

In one embodiment, the scaffold structure is formed as a monolith structure. In various approaches, the scaffold structure is forming using a cast (e.g., investment cast), template, mold, etc. Without wishing to be bound by any theory, addition of a thermite for a cast-formed structure includes addition of a binder for intermixing the thermite into the matrix prior to cast mold thereby resulting in a very poor low explosive. Thus, a thermite is preferably added into the matrix of the scaffold structure for forming a scaffold structure using additive manufacturing techniques. Moreover, subtractive manufacturing techniques such as milling, turning, punch, etc. are not possible for the formation of the scaffold structure for energetic material as described herein. In some approaches, forming an inert scaffold structure may include subtractive manufacturing techniques.

In one embodiment, the structural reinforcing element is additively manufactured to be optimally reinforcing at a minimal volume fraction and with an open cell lattice structure that facilitates uniform incorporation of a cast-curable or melt-case HE, thus providing advantage over extant reinforcement approaches. For example, an optimal structure may be determined via the use of computational design optimization algorithms such that the structure design is optimized to meet design use strength requirements, toolpath optimization to reduce waste or print time, geometric optimization to enhance lattice for maximum HE contact, etc.

According to one embodiment, an ink composition for forming a 3D open cell structure comprising a carbon fiber material with enhanced energy release potential includes a polymer resin comprising a carbon fiber, a fuel additive, and a thixotropic agent. The polymer carbon fiber resin includes a carbon fiber thermoset composite developed using methodology disclosed in U.S. Patent Publication No. 2017/0015060 which is incorporated by reference.

In one approach, a formulation of the ink may include a concentration of the carbon fiber being in a range of greater than 0 to about 60 vol. % of the total ink formulation, and a concentration of the fuel additive being in a range of about 40 vol. % to greater than 0 vol. % of the total ink composition, relative to the concentration of the concentration of the carbon fiber in the ink composition.

A polymer composite reinforcing lattice may be additively manufactured using the ink composition having an additive configured to enhance energy release potential from an energetic material. In various approaches, the reactive, participatory additive may be a fuel output enhancer. In one approach, the additive may include a second class of fuel (such as a metal). The additive, fuel enhancer, second class of fuel, etc. is not considered to be an energetic material. For example, the additive may include aluminum particles, preferably spherical aluminum particles. For example, an ink may include an addition of spherical aluminum particles on the order of 15 μm diameter to the uncured resin blend at loadings of 0 to 60 vol. % with carbon fiber loadings on the order of greater than 0 to 40 vol. % relative to the total volume of the composition. In addition, thixotropic silica loadings in the composition may be adjusted to maintain a shear thinning processable fluid over the loadings range. The aluminum, although encapsulated within the epoxy matrix would be expected to participate to a degree post detonation (in an oxidative, non-oxygen limited environment) in fireball thermal output and total overall release energy.

In one approach, the additive may be an oxidizer for the carbon fiber lattice that may be added directly to the ink formulation to provide a source of energetic oxidation of the lattice structure, post detonation, (irrespective of external arena oxygen content) and potentially contribute significantly to the overall blast output energy of the charge. In one approach, an ink composition may be loaded with a significant volume fraction of a dispersed encapsulated fuel oxidizer mix such as a thermite In one approach, the reactive, participatory additive may be an oxidizer being configured to energetically oxidize the carbon fiber material of the structure.

In another approach, the oxidizer may be encapsulated and dispersed throughout the structure. For example, the formulation of the ink may include perchlorate particles, such as partially flocculated potassium perchlorate microparticles (derived from a non-solvent crash of an aqueous saturated solution of the perchlorate). The perchlorate particles may be encapsulated with a polymer passivation coating. The additively manufactured scaffold may be a carbon fiber reinforced polymer composite formed via an AM direct ink writing process, that is loaded with sufficient volume fraction of a dispersed encapsulated oxidant such as a perchlorate in order to provide oxidation of the “fuel” lattice. In one approach, the perchlorate particles, although encapsulated in the epoxy matrix may preferably energetically oxidize both the carbon fiber and the thermoset matrix post detonation (during the fireball stage) contributing to the overall release energy output of the event.

In one example, during formulation of an uncured resin blend, an oxidizer (e.g., thermite, encapsulated perchlorate, perchlorate salts, etc.) may be added to the resin blend at a loading of 0 to 60 vol. % with carbon fiber loadings on the order of 40 to 0 vol. % concurrently and thixotropic silica loadings adjusted to maintain a shear thinning processable fluid over the loadings range. The perchlorate salts may be added as a micronized dispersion throughout the ink.

In one approach, an ink for DIW AM techniques may be configured to form a polymer-carbon fiber lattice that is thermally converted to a carbon-carbon organic lattice. The carbon-carbon lattice is formed from a carbon fiber resin that demonstrates minimum shrinkage during pyrolization to a stage 1 carbon-carbon structure. The carbon-carbon structure is mechanically robust, for example, having compression strength in a range of 50 to 300 MPa.

In one approach, an optional formulation of the pre-printed lattice “ink” material may include a dispersed fuel, an encapsulated oxidant for the lattice or incorporating a distinct fuel/oxidizer mixture. Carbon fiber-polymer composite lattices, if not undergoing carbonization, may be modified further with fuels, oxidizers, and/or fuel-oxidizer mixtures at the DIW ink formulation stage, prior to printing and cure.

In general, as described below, methods of “energization” of the reinforcing lattice allow different forms of active participation of the lattice in the energy output event (e.g., HE output event, burning of the propellant, etc.) partially at least replacing the loss of energy release potential where this loss represents the difference between the output of energy release potential of a certain volume of energetic material and the output of energy release potential of an equivalent volume of reinforcing lattice that replaces the volume of energetic material. In preferred approaches, the loss of energy release potential of the scaffold structure and energetic material is negligible, near zero, essentially zero, etc. or the energetic participation of the lattice may add second order output effects such as increased late stage fireball output that otherwise compensate for loss of high explosive output. In one exemplary approach, the output of energy release of a product having a volume comprising the scaffold structure and the energetic material is the same or greater than the output of energy release of a product having a similar volume comprising, state of the art mechanically robust and insensitive energetic material without the scaffold structure. For example, the volume-volume performance of an energetic material in a certain volume is unaffected or augmented by the scaffold structure versus state of the art useable HE compositions.

In one approach, a design consideration of a scaffold is a lattice topology and fiber mesostructure that is optimal to resist deformation or failure of the energetic composition under expected forces, such as to resist charge deformation or failure under loads. A key design consideration includes minimizing the volume fraction of the scaffold relative to the volume of the energetic material (e.g., HE composite) in the charge.

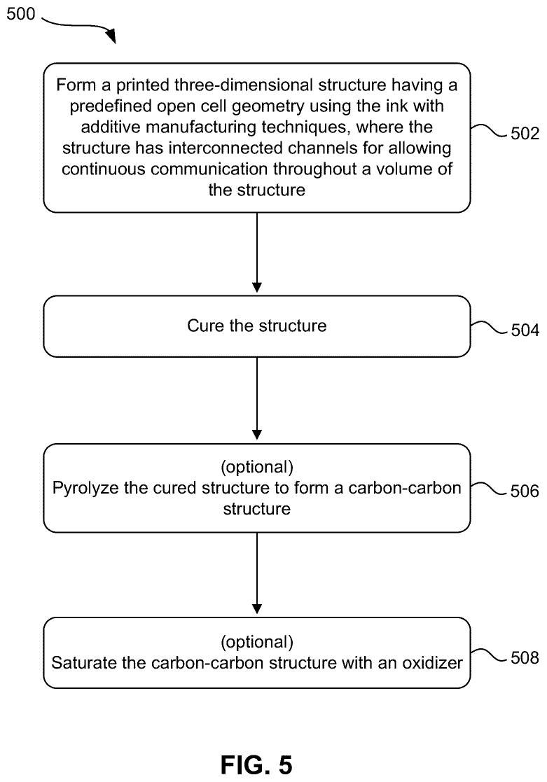

FIG. 5 shows a method 500 for forming a 3D structure having open cell geometry, in accordance with one aspect of one inventive aspect. As an option, the present method 500 may be implemented to construct structures such as those shown in the other FIGS. described herein. Of course, however, this method 500 and others presented herein may be used to form structures for a wide variety of devices and/or purposes which may or may not be related to the illustrative embodiments listed herein. Further, the methods presented herein may be carried out in any desired environment, for example, high rate impact, high sustained acceleration, large magnitude vibrations, shock, etc. Moreover, more or less operations than those shown in FIG. 5 may be included in method 500, according to various embodiments. It should also be noted that any of the aforementioned features may be used in any of the embodiments described in accordance with the various methods.

Method 500 begins with operation 502 of forming a 3D scaffold structure having a predefined open cell geometry. In one approach, the 3D scaffold structure may be formed using a mold, template, cast, etc. In another approach, the 3D scaffold structure may be formed using the ink with AM techniques. The formed scaffold structure has interconnected channels for allowing continuous communication throughout a volume of the structure. In one approach, a design of a scaffold structure may be optimized for mechanical enhancement (e.g., reinforcement of energetic material) of a given energetic composition for a given stress application environment. The 3D structure, e.g., a scaffold, may be formed using DIW-based AM techniques on the optimized design. In a preferred approach, DIW technologies for carbon fiber thermoset composites may be employed using methodology disclosed in U.S. Patent Publication No. 2017/0015060 which is incorporated by reference. Preferably, the printed 3D scaffold structure has interconnected channels for allowing continuous communication throughout at least a portion of the volume of the scaffold structure.

Beginning with the design requirements (e.g., charge geometry, HE mechanical properties, HE rheological properties, expected dynamic loading parameters, etc.) a CAD file of the energetic product (e.g., charge) and the scaffold structure (e.g., a lattice) may be produced. A series of computational design optimization processes may be carried out for the topological lattice structure and toolpath carbon fiber alignments to yield a computer numeric control code (e.g., a G-code) based model describing an open celled lattice having the following major design features. The process of optimizing a predefined toolpath for forming a 3D structure as described includes using methodology as described in U.S. Patent Publication 2020/0055252, incorporated herein by reference.

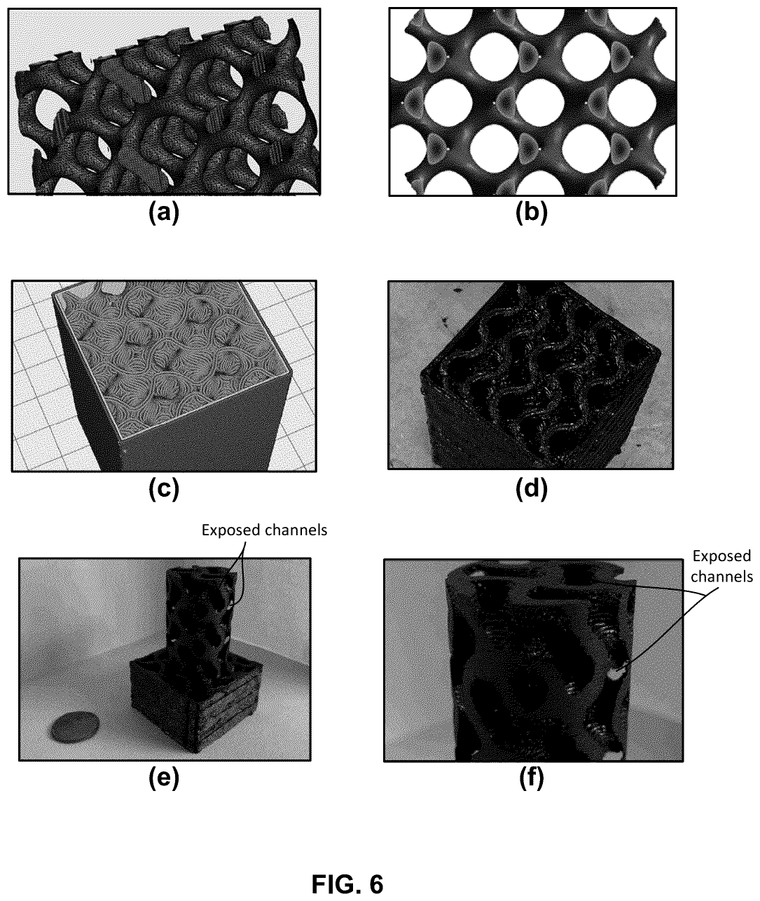

According to one embodiment, AM carbon fiber lattices may be designed and printed with isotropic controlled porosity. A preferred geometry of a lattice having a high surface area and forming continuous channels is a TPMS lattice. In one example, as illustrated in FIG. 6, an initial step may include designing a gyroid lattice concept (part (a)), using predefined parameters to create an optimized computational design. For example, predefined parameters may include strength requirements for a specific energetic material, strength requirements for intended application, toolpath for reduced waste and/or print times, enhanced lattice geometric pattern for maximum HE contact, etc. A model scaffold structure (part (b)) is created as having a scaffold material volume of about 20 vol. % of a charge (configured for a charge having 80 vol. % energetic material). Part (c) illustrates developing a DIW toolpath for the gyroid shape of the scaffold structure.

In one approach, the predefined open cell geometry may be selected based on properties of an energetic material configured to be contained by the scaffold structure. For example, the following properties of the energetic material (e.g., HE composite) may be considered: geometry, mechanical properties, rheological properties, burn rate, energetic output, blast strength, etc. These properties of the energetic material are by way of example only and are not meant to be limiting in any way. Another design consideration includes the scaffold having an open celled interconnected lattice structure that provides communication and interconnection between the energetic material throughout the volume. Moreover, continuous channels through the open celled interconnected lattice structure represent a wholly communicative and contiguous geometry without any dead-end cavities or constrictions that would preclude the chosen energetic intercalation without void formation. For example, a preferred energetic intercalation is the rapid burning of the energetic material in a continuous manner, e.g., the uninterrupted clean burn without a need or possibility to double back for a lateral burn. Alternatively, pseudo-cavitation occurs when energetic material (e.g., HE material) and the scaffold structure lose directly contact thereby resulting in unanticipated and unmodeled detonation.

In one example of a DIW-based AM process, a short-carbon fiber loaded UV gellable thermoset ink may be deposited using a 3 to 6 axis motion control stage, controlled by the G-code that is the final output of the design optimization stage. In one example, a final output structure of a carbon fiber gyroid lattice printed using the DIW-based AM process is shown in part (d) of FIG. 6. This approach is by way of example only and is not meant to be limiting in any way.

In one approach, a support material may be (temporarily) included during a “wet” AM process to provide structural scaffolding of the matrix material. The support material may be a sacrificial material, such that the temporary support material is removed chemically, mechanically, etc. once the matrix material of the main scaffold structure is cured. The inclusion of a sacrificial support material may allow for better print predictability, precision, and/or large ranges in unit cell density gradation. For example, in one approach, a separate sacrificial support material may be co-extruded using a separate nozzle, controlled by a complementary support G-code generated by either a commercial CAD/G-code slicer or a customized algorithm as part of the design optimization process.

Referring back to FIG. 5, operation 504 of method 500 includes curing the scaffold structure. For example, a green strength gelled part may be thermally cured according to a cure schedule suitable for the thermoset resin and curative employed. In some approaches, the scaffold structure formed by DIW processes is cured following the printing step. The curing step includes heating the printed scaffold structure at a temperature in a range of room temperature to about 150° C. for a duration of time. In an exemplary approach, the curing includes heating the scaffold structure to 150° C. for 16 hours. Temperatures higher than 220° C. may induce decomposition of the material in the scaffold structure. In other approaches, such as fused deposition molding (FDM) and stereolithography (SLA) processes, forming the scaffold structure may not include a curing step.

In one approach, the cured part may be machined to final dimensions and tolerances. In one approach, a cured scaffold structure is machined to expose the interconnected channels at the sides of the scaffold structure. Referring back to FIG. 6, a cured gyroid lattice is machined to expose the interconnected channels at the sides of the scaffold structure in parts (e) and (f). Part (e) shows both the pre-machined part at the bottom and the machined part at the top with the exposed channels. In one approach, the completed fiber-polymer composite lattice may be used directly as a reinforcer for a castable and melt castable energetic material.

Referring back to FIG. 5, in one approach of method 500, an optional operation 506 includes pyrolyzing the cured scaffold structure to form a an organic carbon scaffold structure (e.g., carbon-carbon structure). A printed fiber-polymer composite lattice may be thermally converted to an inorganic ceramic lattice. For example, the printed lattice may be thermally converted at temperatures of 1050° C. or above over an extended time period in reductive environment to form an inorganic carbon-carbon composite. Preferably, the composite is a “stage 1” pyrolytic carbon-carbon material and as such its bulk scaffold structure is mechanically robust but not fully dense and the surface area is relatively high versus full density carbon-carbon material. For example, for an approximately 40 vol. % carbon fiber loaded aromatic epoxy based printed composite, pyrolyzed in such a manner, a measured BET surface areas is about 147 m²/g. It is important to note that the relatively high surface area of the stage 1 pyrolytic carbon may provide a higher number of available carbon atoms to be chemically functionalized with an oxidizing moiety, e.g., Nitro groups. For example, the available number of carbon atomic surface sites on the high surface area carbon-carbon material allow a large enough number of nitro groups to be chemically grafted onto the carbon surface—to allow a significant portion of the total mass of the carbon lattice to be oxidized on ignition. In an exemplary approach, greater than 90% of available surface carbons (sites) are functionalized with nitro groups in order to burn about 50% of the total mass of the scaffold structure. The surface area provided by the stage 1 carbon-carbon lattice is preferable for participation in energetic output from the oxidant (e.g., oxidizer).

Further, the carbon-carbon scaffold part may be functionalized to provide an oxidant component. In one approach, the carbon atoms on the surface of the carbon-carbon scaffold structure may be chemically functionalized with nitro groups (—NO₂). For example, a chemically functionalized carbon-carbon ceramic lattice provides an oxidizer component to the lattice and allows its active participation in the energy output event. In other approaches, the carbon-carbon scaffold structure may be fluorinated for partial energization. In some approaches, the carbon-carbon scaffold structure may be functionalized with complex chemical moieties, such as triamines, for selected explosive applications.

Several preparative methods may be employed to functionalize this high surface area carbon, covalently including direct acidic nitration with nitric/sulfuric acid mixtures at below ambient temperatures or amination of the carbon surface followed by conversion to Nitro groups. The now functionalized carbon-carbon is neutralized with an inorganic carbonate solution and washed several times with distilled water to remove any reaction residues that may impact the chemical compatibility of the lattice with the energetic material.

In one approach of method 500, an optional operation 508, after converting the scaffold structure material to a carbon-carbon material, includes saturating the carbon-carbon structure with an oxidizer. For example, the carbon-carbon structure may be soaked in a concentrated solution of perchlorate particles or nitrate salts so that the chlorate particles penetrate the surface and pores of the interconnected channels of the scaffold structure. The scaffold structure may be dried thereby resulting in crystalline perchlorate throughout the matrix of the scaffold structure.

In one approach, the method further includes intercalation and curing of the HE composition within the scaffold structure (e.g., lattice). The method includes filling the interconnected channels with an energetic material. In one example, a mold form having fill holes or ports may house the scaffold structure so that the energetic material may be loaded into the scaffold structure (e.g., lattice). The mold encapsulates the scaffold structure and the energetic material (e.g., HE material) is injected into the interconnected channels of the scaffold structure via fill holes or ports while air is evacuated from the scaffold structure (via the channels).

In one approach, a melt castable or castable-curable energetic composition (for example LX-20 or RDX) that is capable of free-flowing behavior is conveyed into the pores of the scaffold structure (e.g., lattice) with air pressure, hydraulic pressure, or mechanical piston/screw driven ram/syringe assembly. If the scaffold structure is open on all sides (as depicted as having exposed channels 406 in scaffold structure 400 of FIG. 4), the scaffold structure may be held in a multipart mold with fill ports to constrain the fluid flow until the part is completely filled. Mass/volumetric density may be used to verify the completion of the fill. Mechanical vibration and/or vacuum assisted injection molding methods may be utilized to facilitate filling of the lattice structure. Once filled, the energetic material is allowed to thermally set or chemically cure depending on the composition of the energetic material.

Alternatively, in some approaches, the scaffold structure and/or the munition structure includes outer wall(s) of fully dense matrix material (e.g., the outer walls do not have open channels) on one or more of the surfaces of the inner cavity of the munition structure. The scaffold structure having the outer walls may be filled with the energetic material without the use of a mold for filling. The outer wall(s) may provide mechanical isolation and/or thermal insulation of energetic material (e.g., HE material, propellant, etc.) from the outer surfaces of the energetic product (e.g., munition, solid rocket, etc.).

### In Use

Various aspects of an inventive aspect described herein may be developed for mechanical stabilization of high output yield energetic material compositions which otherwise may have reduced mechanical integrity and reduced performance, and in some cases, may not survive, high dynamic stress environments such as applied force, high speed acceleration, etc. For example, one embodiment describes scaffolds for mechanical stabilization of high output yield HE compositions to have sufficient mechanical integrity to survive such high dynamic stress environments such as high velocity gun launch, high speed penetration events for ammunition, etc.

The inventive aspects disclosed herein have been presented by way of example to illustrate the myriad features thereof in a plurality of illustrative scenarios, aspects of an inventive aspect, and/or implementations. It should be appreciated that the aspects generally disclosed are to be considered as modular, and may be implemented in any combination, permutation, or synthesis thereof. In addition, any modification, alteration, or equivalent of the presently disclosed features, functions, and aspects that would be appreciated by a person having ordinary skill in the art upon reading the instant descriptions should also be considered within the scope of this disclosure.

While various aspects of an inventive aspect have been described above, it should be understood that they have been presented by way of example only, and not limitation. Thus, the breadth and scope of an aspect of an inventive aspect of the present invention should not be limited by any of the above-described exemplary aspects of an inventive aspect, but should be defined only in accordance with the following claims and their equivalents.

What is claimed is:

1. A product, comprising:
a three-dimensional scaffold structure having an open cell geometry with interconnected channels for allowing continuous communication throughout a volume of the scaffold structure, the scaffold structure being configured to enhance mechanical strength of an energetic material,
wherein a fuel material is present in the scaffold structure and/or a second material is coupled to the scaffold structure, wherein the fuel material is configured to increase an output of energy release relative to an output of energy release from the scaffold structure having the fuel material not present.

2. The product as recited in claim 1, wherein the fuel material includes a stage 1 carbon material.

3. The product as recited in claim 1, wherein the fuel material includes a chemically functionalized carbon material.

4. The product as recited in claim 1, wherein the fuel material comprises a polymer carbon fiber material and the second material, the second material being an oxidizer encapsulated into the polymer carbon fiber material.

5. The product as recited in claim 4, wherein the oxidizer includes a chlorate functionalizer.

6. The product as recited in claim 1, wherein the scaffold structure is comprised of a thermoset composite matrix having a fuel-oxidizer mixture therein, wherein the fuel-oxidizer mixture comprises the fuel material being selected from the group consisting of: a metal powder, a carbon powder, and a carbon-sulfur powder, and the second material being an oxidizer.

7. The product as recited in claim 6, wherein the thermoset composite matrix includes a high-explosive energetic powder.

8. The product as recited in claim 1, wherein the scaffold structure is a graded lattice having a predefined gradient of density of scaffold material, wherein the graded lattice comprises a first region having a first unit density of the scaffold material, and a second region having a second unit density of the scaffold material, wherein the first unit density is different than the second unit density.

9. The product as recited in claim 1, further comprising,
an energetic material present in the interconnected channels of the scaffold structure,
wherein a volume of the energetic material is greater than 75 volume % of a total volume of the product.

10. An ink composition for forming a three-dimensional scaffold open cell structure for energetic material, the ink composition comprising:
a polymer resin comprising a carbon fiber;
an additive configured to enhance energy release potential from the energetic material; and
a thixotropic agent.

11. The ink composition as recited in claim 10, wherein a formulation of the ink composition comprises:
a concentration of the carbon fiber being in a range of greater than 0 to about 60 volume % of the total ink composition,
a concentration of the additive being in a range of greater than 0 volume % to about 40 volume % of the total ink composition.

12. The ink composition as recited in claim 10, wherein the additive includes aluminum particles.

13. The ink composition as recited in claim 10, wherein the additive includes an oxidizer being configured to energetically oxidize a carbon fiber material formed from the ink composition.

14. The ink composition as recited in claim 13, wherein the oxidizer includes perchlorate particles.

15. The ink composition as recited in claim 10, wherein composition is configured to form a polymer-carbon fiber lattice that is thermally convertible to a carbon-carbon lattice.

16. A method of forming a three-dimensional scaffold structure having open cell geometry using the ink composition as recited in claim 10, the method comprising:
forming the three-dimensional scaffold structure having a predefined open cell geometry using the ink composition with additive manufacturing techniques,
wherein the scaffold structure has interconnected channels for allowing continuous communication throughout a volume of the scaffold structure; and
curing the scaffold structure.

17. The method as recited in claim 16, wherein the predefined open cell geometry is selected based on properties of an energetic material configured to be contained by the scaffold structure, wherein at least one property of the energetic material is selected from the group consisting of: mechanical property, rheological property, burn rate, energetic output, blast strength, and geometry.

18. The method as recited in claim 16, further comprising,
pyrolyzing the cured scaffold structure to form a carbon scaffold structure.

19. The method as recited in claim 18, wherein carbon atoms on a surface of the carbon scaffold structure are functionalized with nitro groups.

20. The method as recited in claim 18, further comprising saturating the carbon scaffold structure with an oxidizer.

21. The method as recited in claim 16, further comprising filling the interconnected channels with an energetic material.
